(19) United States
(12) Patent Application Publication
(10) Pub. No.: US 2026/0027853 A1
(43) Pub. Date: Jan. 29, 2026

(54) WHEEL BEARING APPARATUS FOR VEHICLE

(71) Applicant: HYUNDAI MOBIS CO., LTD., Seoul (KR)

(72) Inventor: Seung Hwan CHA, Yongin-si (KR)

(73) Assignee: HYUNDAI MOBIS CO., LTD., Seoul (KR)

(21) Appl. No.: 19/169,830

(22) Filed: Apr. 3, 2025

(30) Foreign Application Priority Data
Jul. 29, 2024 (KR) 10-2024-0100412

(51) Int. Cl. B60B 27/00

(52) U.S. Cl. CPC B60B 27/0005; B60B 27/0068; B60B 27/0073

(57) ABSTRACT

A wheel bearing apparatus including a hub part configured to be connected to a wheel of a vehicle, an inner wheel part provided on an outside of the hub part, the inner wheel part being configured to rotate together with the hub part, an outer wheel part disposed spaced apart from the inner wheel part and fixed to a vehicle body of the vehicle, a bearing part disposed between the inner wheel part and the outer wheel part, the bearing part being configured to rotatably support the inner wheel part relative to the outer wheel part, a retainer part coupled to the bearing part, the bearing part being configured to support the bearing part, an encoder part mounted on the hub part, the encoder part being configured to cover the inner wheel part and to rotate in conjunction with a rotation of the hub part, the encoder part being magnetic, and a seal part mounted between the inner wheel part and the outer wheel part, the seal part being configured to block foreign substances from entering the bearing part.

### CROSS-REFERENCE TO RELATED APPLICATION

This application claims priority from and the benefit under 35 USC § 119 of Korean Patent Application No. 10-2024-0100412, filed on Jul. 29, 2024, in the Korean Intellectual Property Office, the entire disclosure of which is incorporated by reference for all purposes.

### BACKGROUND

### 1. Field

Exemplary embodiments of the present disclosure relate to a wheel bearing apparatus for a vehicle and, more particularly, to a wheel bearing apparatus for a vehicle, capable of reducing friction between a retainer and a bearing and improving fuel efficiency.

### 2. Description of the Related Art

In conventional wheel bearings, retainers are installed in each row to surround the entire circumference of balls so that the balls inside are aligned and can roll. A seal is installed on the inside of the wheel bearing to prevent foreign substances from entering.

In the case of a four-wheel drive vehicle, in order to operate a wheel speed sensor, an encoder ring is applied to the seal to sense by pole number (N-S pole). In addition, in order to provide preload, a metal plate is applied to a drive shaft contact surface after orbital forming to improve the joint caused by slip.

However, because the encoder that detects the wheel speed sensor is applied to the seal inside the vehicle, the range of a magnetic rubber is limited. There is a limit to widely applying the magnetic rubber to expand the sensing range of the wheel speed sensor.

In addition, because the retainer surrounds the entire ball, the friction range between the seal and the ball is large, and there is a problem that fuel efficiency is reduced due to friction during rotation. Therefore, there is a need to improve the fuel efficiency.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a wheel bearing apparatus including a hub part configured to be connected to a wheel of a vehicle, an inner wheel part provided on an outside of the hub part, the inner wheel part being configured to rotate together with the hub part, an outer wheel part disposed spaced apart from the inner wheel part and fixed to a vehicle body of the vehicle, a bearing part disposed between the inner wheel part and the outer wheel part, the bearing part being configured to rotatably support the inner wheel part relative to the outer wheel part, a retainer part coupled to the bearing part, the bearing part being configured to support the bearing part, an encoder part mounted on the hub part, the encoder part being configured to cover the inner wheel part and to rotate in conjunction with a rotation of the hub part, the encoder part being magnetic, and a seal part mounted between the inner wheel part and the outer wheel part, the seal part being configured to block foreign substances from entering the bearing part.

The retainer part may include a retainer body part, the retainer body part being configured in an annular shape, the retained body part being disposed between the inner wheel part and the outer wheel part and a retainer support part protruded outwardly from the retainer body part, the retainer support part being configured to rotatably support ball members of the bearing part.

The retainer part further may include a retainer weight reducing perforation, the retainer weight reducing perforation being defined within the retainer body part.

The encoder part may include an encoder body part mounted on the hub part, the encoder body part being configured to cover the inner wheel part and to rotate in conjunction with the rotation of the hub part and an encoder magnetic rubber part mounted on the encoder body part, the encoder magnetic rubber part including a magnetic material.

The encoder body part may include an encoder cap mounted on the hub part and an encoder flange formed stepwise on the encoder cap, the encoder flange being configured to cover the inner wheel part, the encoder flange including the encoder magnetic rubber part.

The encoder body part may include Teflon coated provided on a steel material.

The seal part may include a seal body part mounted between the inner wheel part and the outer wheel part, a seal elastic part mounted on an edge of the seal body part and including an elastically deformable material, and a seal fixing part mounted on the seal elastic part, the seal fixing part being configured to support the seal elastic part.

The seal elastic part may include a seal elastic body part disposed on an edge of the seal body part, a seal elastic extension part disposed to extend from one side of the seal elastic body part to the seal body part, and a seal elastic receiving part disposed on an other side of the seal elastic body part, the seal elastic part configured to receive the seal fixing part therein.

The wheel bearing apparatus may include a plurality of seal elastic extension parts disposed within the seal elastic body part.

The seal body part may include an engineering plastic material.

### BRIEF DESCRIPTION OF THE DRAWINGS

FIG. 1 is a perspective view schematically illustrating a wheel bearing apparatus for a vehicle according to an embodiment of the present disclosure.

FIG. 2 is a schematic cross-sectional view taken along line A-A in FIG. 1.

FIG. 3 is a partially enlarged cross-sectional view illustrating portion “B” in FIG. 2.

FIG. 4 is a perspective view schematically illustrating a state in which a bearing part is mounted on a retainer part in an embodiment of the present disclosure.

FIG. 5 is a side view schematically illustrating a state in which a bearing part is mounted on a retainer part in an embodiment of the present disclosure.

FIG. 6 is a perspective view schematically illustrating a retainer part according to an embodiment of the present disclosure.

FIG. 7 is a side view schematically illustrating a bearing part and a retainer part according to an embodiment of the present disclosure.

FIG. 8 is a perspective view schematically illustrating an encoder part according to an embodiment of the present disclosure.

FIG. 9 is a cross-sectional view schematically illustrating a retainer part according to an embodiment of the present disclosure.

FIG. 10 is a partially enlarged cross-sectional view schematically illustrating portion “C” in FIG. 9.

FIG. 11 is a perspective view schematically illustrating a seal part according to an embodiment of the present disclosure.

FIG. 12 is a perspective view schematically illustrating a seal part according to an embodiment of the present disclosure.

FIG. 13 is a partially enlarged cross-sectional view schematically illustrating portion “D” in FIG. 12.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

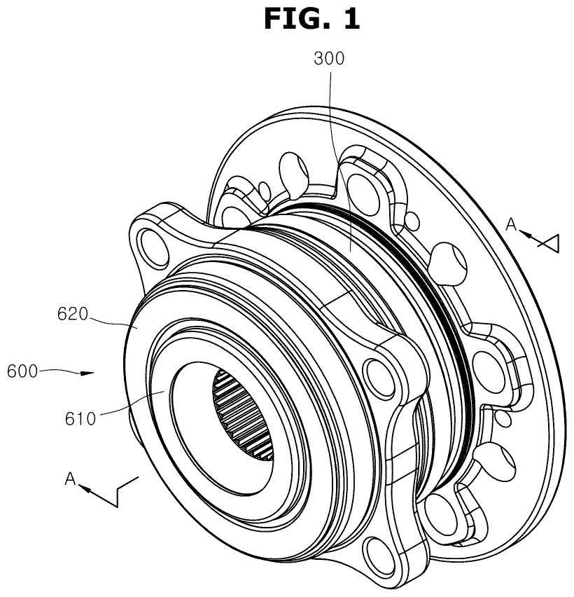

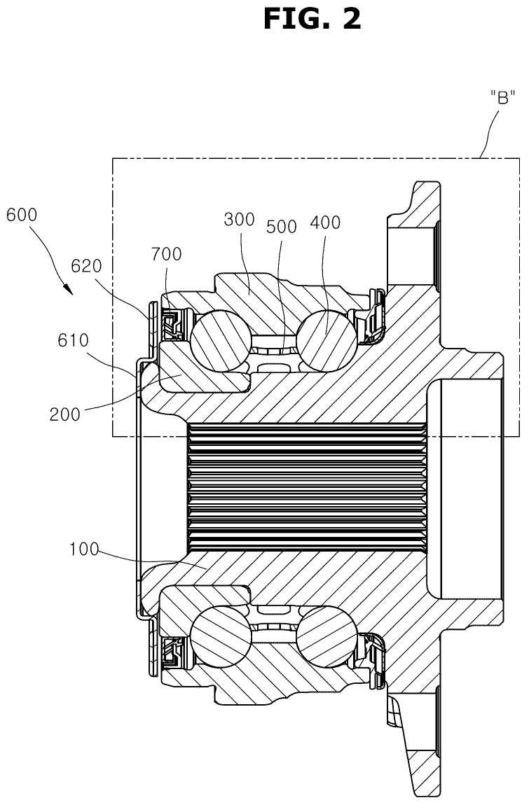

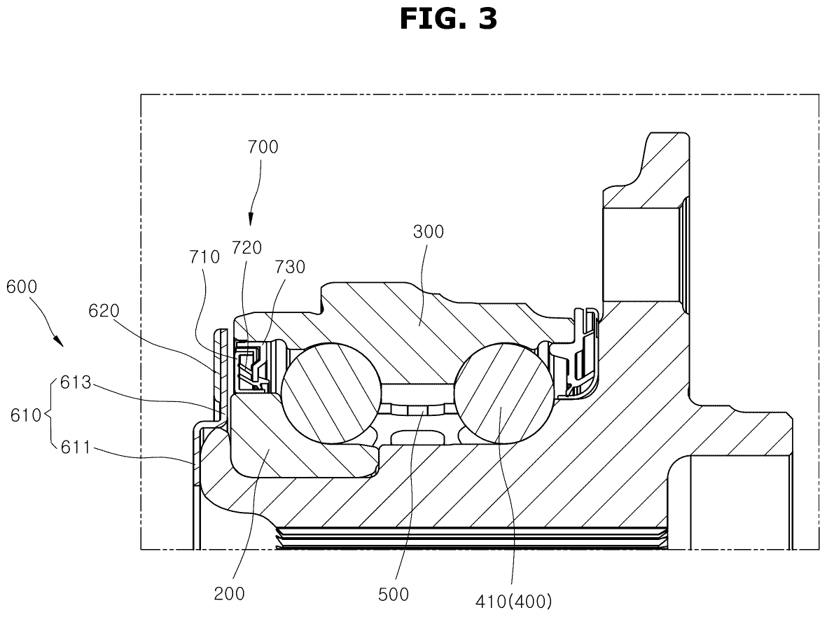

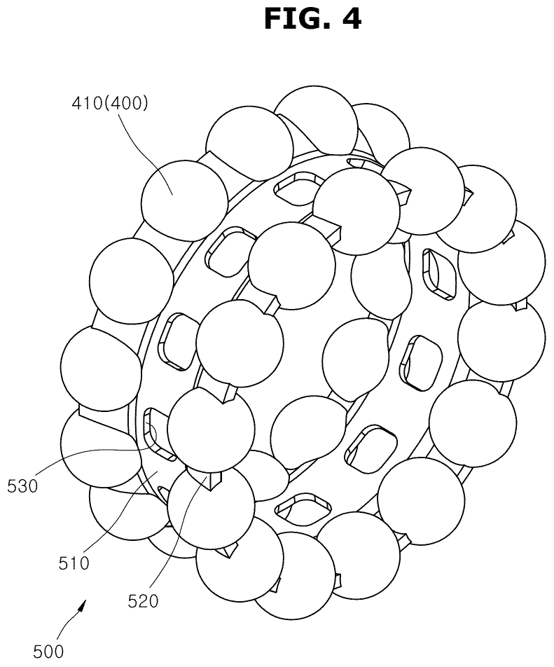

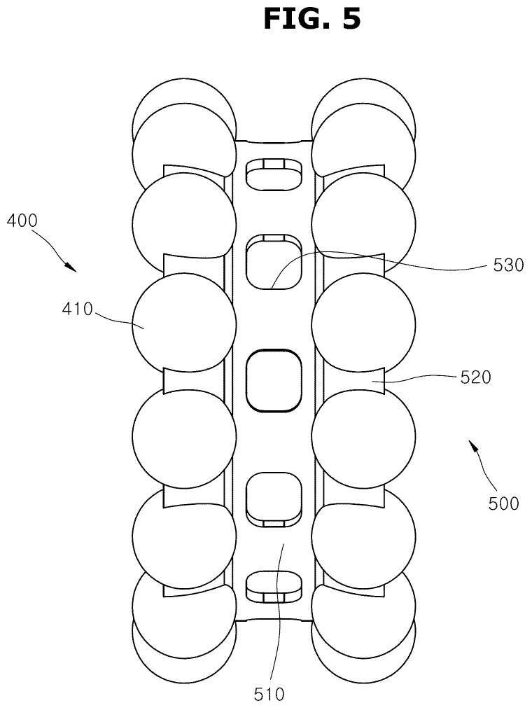

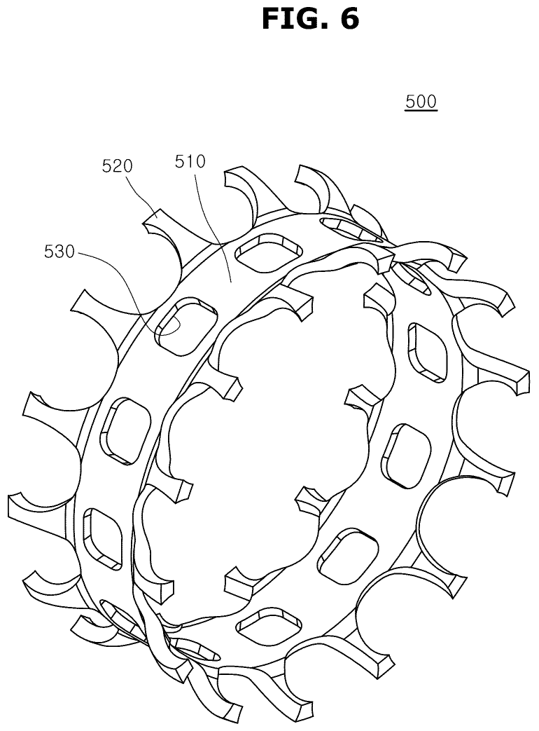

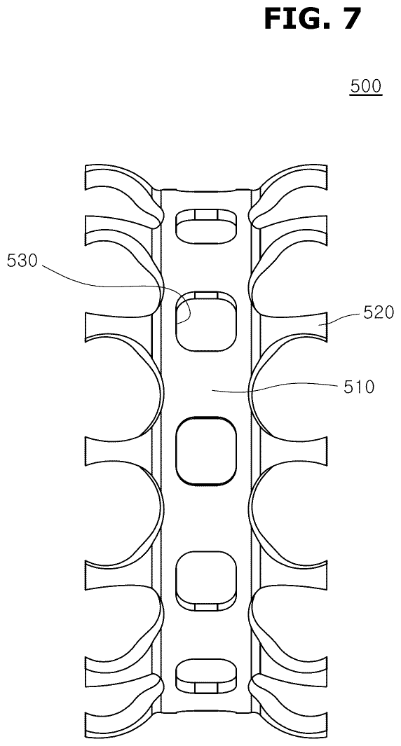

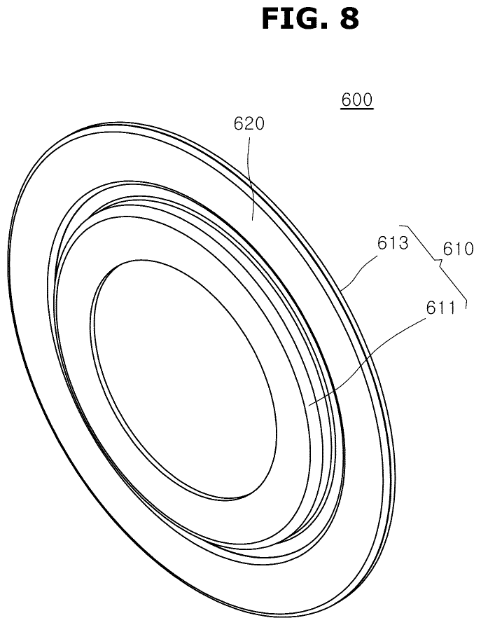

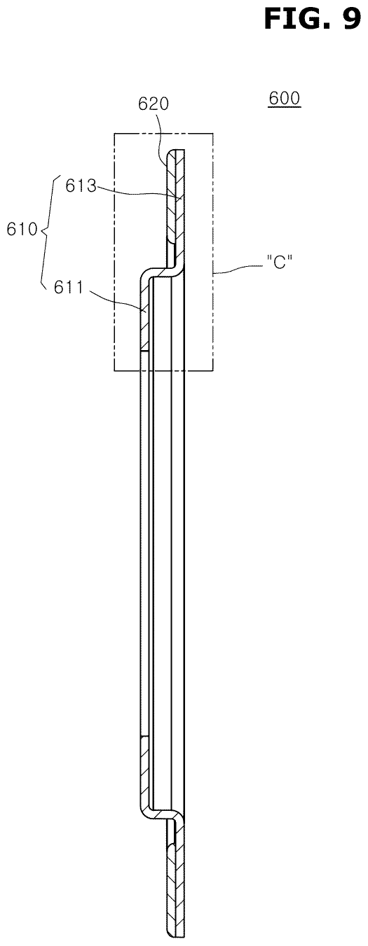

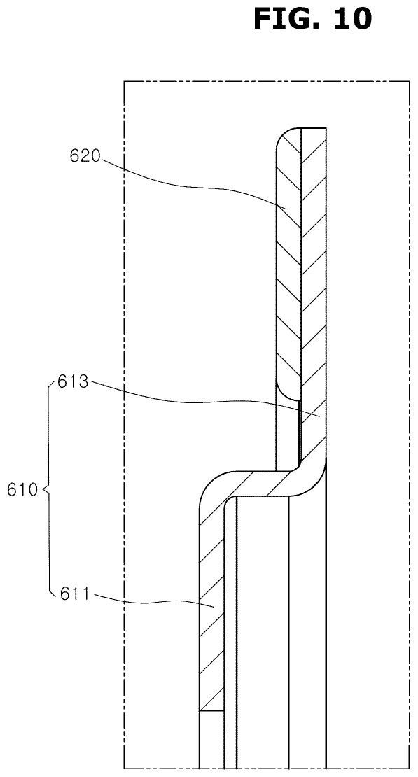

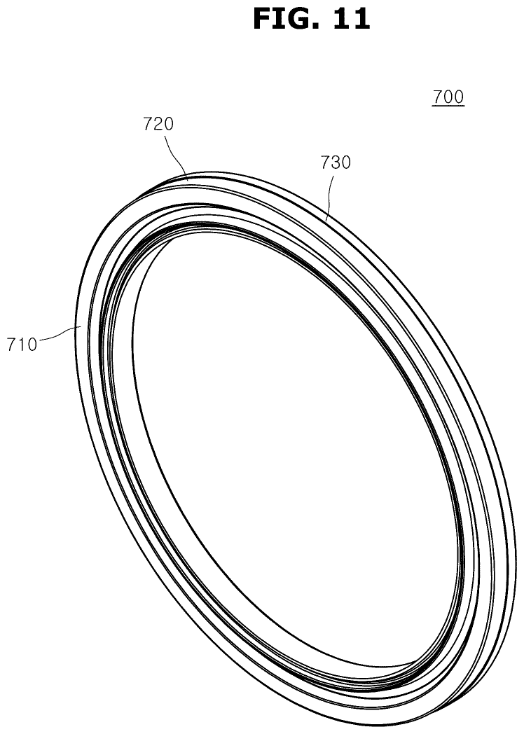

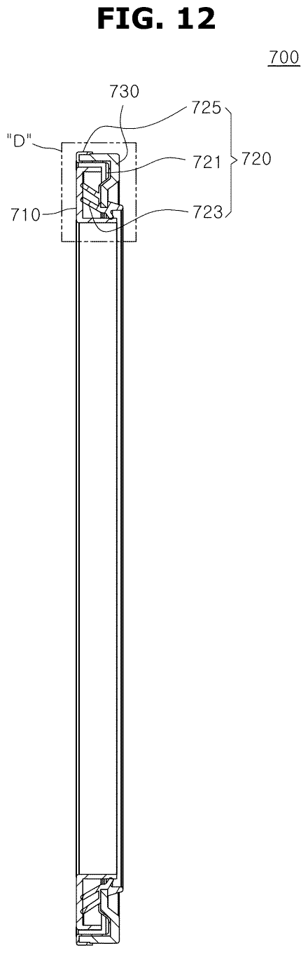

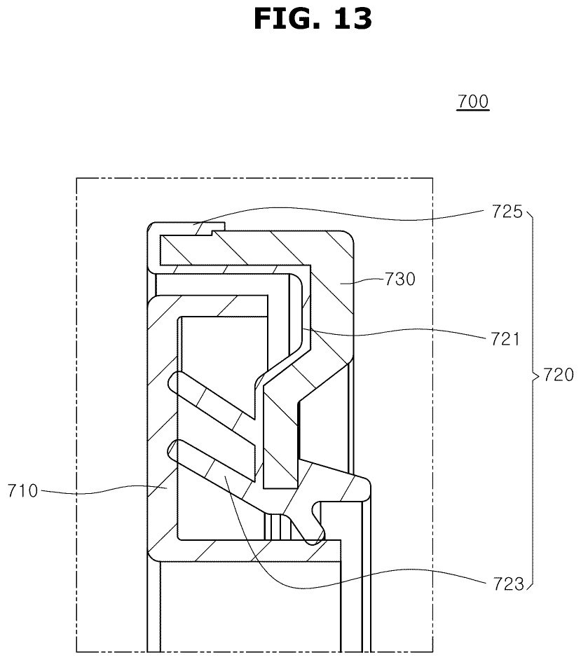

FIG. 1 is a perspective view schematically illustrating a wheel bearing apparatus for a vehicle according to an embodiment of the present disclosure. FIG. 2 is a cross-sectional view taken along line A-A in FIG. 1. FIG. 3 is a partially enlarged cross-sectional view illustrating portion “B” in FIG. 2. FIG. 4 is a perspective view schematically illustrating a state in which a bearing part is mounted on a retainer part in an embodiment of the present disclosure. FIG. 5 is a side view schematically illustrating a state in which a bearing part is mounted on a retainer part in an embodiment of the present disclosure. FIG. 6 is a perspective view schematically illustrating a retainer part according to an embodiment of the present disclosure. FIG. 7 is a side view schematically illustrating a bearing part and a retainer part according to an embodiment of the present disclosure. FIG. 8 is a perspective view schematically illustrating an encoder part according to an embodiment of the present disclosure. FIG. 9 is a cross-sectional view schematically illustrating a retainer part according to an embodiment of the present disclosure. FIG. 10 is a partially enlarged cross-sectional view schematically illustrating portion “C” in FIG. 9. FIG. 11 is a perspective view schematically illustrating a seal part according to an embodiment of the present disclosure. FIG. 12 is a perspective view schematically illustrating a seal part according to an embodiment of the present disclosure. FIG. 13 is a partially enlarged cross-sectional view schematically illustrating portion “D” in FIG. 12.

Referring to FIG. 1 to FIG. 13, the wheel bearing apparatus for a vehicle, according to an embodiment of the present disclosure includes a hub part 100, an inner wheel part 200, an outer wheel part 300, a bearing part 400, a retainer part 500, an encoder part 600, and a seal part 700.

The hub part 100 forms the appearance of one side of the wheel bearing apparatus for a vehicle, according to an embodiment of the present disclosure, and supports the inner wheel part 200, the bearing part 400, the retainer part 500, the encoder part 600, and the seal part 700, which will be described later. The hub part 100 is connected to the wheels of the vehicle.

A drive shaft (not shown) may be coupled to the inside of the hub part 100. The hub part 100 rotates together with the drive shaft and functions as a rotating element that transmits the rotational force generated from the drive shaft to the wheels. The hub part 100 may have a hollow cylindrical shape and be arranged in a direction parallel to the axial direction of the wheels. The drive shaft may be inserted into the inside of the hub part 100 through the hollow portion of the hub part 100.

The inner wheel part 200 is provided on the outside of the hub part 100 and rotates together with the hub part 100. The inner wheel part 200 is coupled to the hub part 100 and rotates together with the hub part 100 when the hub part 100 rotates.

The outer wheel part 300 is disposed spaced apart from the inner wheel part 200 and is fixed to a vehicle body (not shown). The outer wheel part 300 forms the appearance in the wheel bearing apparatus for the vehicle, according to the present disclosure and is disposed spaced apart from the inner wheel part 200. The outer wheel part 300 may be fixed to a vehicle body to function as a non-rotating element that does not rotate together with the hub part 100 and the inner wheel part 200 when the wheels rotate.

The outer wheel part 300 has a hollow cylindrical shape. The outer wheel part 300 may be disposed to face to the inner wheel part 200 and the outer surface of the hub part 100 at a preset distance in a radial direction of the hub part 100.

The bearing part 400 is disposed between the inner wheel part 200 and the outer wheel part 300 and rotatably supports the inner wheel part 200 relative to the outer wheel part 300.

That is, the bearing part 400 is provided between an empty space formed between the outer wheel part 300 and the hub part 100 and inner wheel part 200 to support the relative rotation of the hub part 100 and the inner wheel part 200 with respect to the outer wheel part 300.

The bearing part 400 may be a rolling bearing. The bearing part 400 includes ball members 410. Each of the ball members 410 may be a steel ball having a circular cross-section. The plurality of ball members 410 of the bearing part 400 may be rotatably arranged along the circumferential direction of the retainer part 500.

The retainer part 500 is coupled to the bearing part 400 to support the bearing part 400. The retainer part 500 includes a retainer body part 510 and a retainer support part 520.

The retainer body part 510 is disposed between the inner wheel part 200 and the outer wheel part 300, and has an annular shape having a set width.

The retainer support part 520 is disposed to protrude outwardly from the retainer body part 510 and rotatably supports the ball members 410 of the bearing part 400. The retainer support part 520 may be disposed in a pair to surround the outer surface of the ball members 410 along the circumferential direction of the retainer body part 510.

The retainer support part 520 is disposed to protrude outwardly in the left and right directions from the retainer body part 510 based on FIG. 5. The retainer support part 520 is disposed to surround a portion of each of the spherical ball members 410. The retainer support part 520 may rotatably surround half of each of the ball members 410.

The retainer support part 520 is disposed to surround a portion of each of the spherical ball members 410, so that friction surfaces between the retainer part 500 and the ball members 410 of the bearing part 400 are reduced, thereby reducing drag force and improving fuel efficiency.

The retainer part 500 may further include retainer weight reducing parts 530. The retainer weight reducing parts 530 (e.g., perforations) are disposed penetrating (i.e., defined within) the retainer body part 510. A plurality of retainer weight reducing parts 530 may be disposed penetrating the retainer body part 510 along the circumferential direction. The retainer weight reducing parts 530 may be disposed penetrating the retainer body part 510 having a set thickness.

The retainer weight reducing parts 530 are disposed penetrating the retainer body part 510, thereby reducing the weight of the retainer part 500. By reducing the weight of the retainer part 500 through the retainer weight reducing parts 530, the fuel efficiency can be improved.

The encoder part 600 is mounted on the hub part 100 to cover the inner wheel part 200, rotates in conjunction with the rotation of the hub part 100, and is provided with a magnetic property or magnetic substance (i.e., magnetism). A wheel speed sensor (not shown) may be disposed on a front side (left side based on FIGS. 2 and 3) of the encoder part 600. The wheel speed sensor detects the speed of the vehicle by monitoring the change in magnetism of the encoder part 600 that rotates according to the rotation of the wheel.

The encoder part 600 is mounted on the other side of the inner wheel part 200 and generates a change in the magnetic field in conjunction with the rotation of the hub part 100. That is, the encoder part 600 rotates together with the hub part 100 and changes the surrounding magnetic field at a constant cycle depending on the rotation speed, rotation direction, etc. of the hub part 100.

The encoder part 600 has a ring shape and has magnetism to generate a change in magnetic field when rotated. The encoder part 600 may be formed so that an N pole and an S pole are arranged alternately along the circumferential direction.

The encoder part 600 includes an encoder body part 610 and an encoder magnetic rubber part 620. The encoder body part 610 is mounted on the hub part 100 to cover the inner wheel part 200, and rotates in conjunction with the rotation of the hub part 100. The encoder body part 610 has a ring shape mounted on the hub part 100. The encoder body part 610 has a size that allows the encoder body part 610 to cover the inner wheel part 200.

The encoder body part 610 includes an encoder cap 611 and an encoder flange 613. The encoder cap 611 is mounted on the hub part 100. The encoder cap 611 is disposed to surround the hub part 100. The encoder cap 611 may be rotated according to the rotation of the hub part 100. The encoder cap 611 may be fixed to the hub part 100 by press-fitting, welding, bolting, or the like.

The encoder flange 613 is formed stepwise on the encoder cap 611, covers the inner wheel part 200, and is provided with an encoder magnetic rubber part 620. The encoder flange 613 may be formed stepwise from the encoder cap 611 toward the inner wheel part 200. The encoder magnetic rubber part 620 may be vulcanized and bonded to the encoder flange 613.

The encoder flange 613 may have a size to cover the inner wheel part 200. The encoder flange 613 may have a size to cover the inner wheel part 200, thereby preventing foreign substances from entering the inner wheel part 200 and the bearing part 400.

In addition, the encoder flange 613 has a size to cover the inner wheel part 200, so that the area where the encoder magnetic rubber part 620 is mounted on the encoder flange 613 increases and the sensing capability can be improved.

The encoder body part 610 may be formed by coating Teflon on a steel material. The encoder body part 610 may be manufactured simply by coating or injection-molding Teflon on the steel material, and may have a reduced weight compared to a body part formed only of steel material.

The encoder magnetic rubber part 620 is mounted on the encoder body part 610 and may be provided with magnetism. A magnetic rubber (rubber with an N-S polarity) imparted with magnetism may be applied to the encoder magnetic rubber part 620.

The encoder magnetic rubber part 620 may be vulcanized and bonded to the encoder flange 613 of the encoder body part 610. The encoder magnetic rubber part 620 is mounted on the encoder flange 613 and rotates depending on the rotation of the hub part 100, and the wheel speed sensor detects the speed of the wheel by monitoring the magnetic change of the encoder magnetic rubber part 620.

The seal part 700 is installed between the inner wheel part 200 and the outer wheel part 300 and blocks foreign substances from entering the bearing part 400.

The seal part 700 includes a seal body part 710, a seal elastic part 720, and a seal fixing part 730. The seal body part 710 is mounted between the inner wheel part 200 and the outer wheel part 300. The seal body part 710 has an annular shape and is mounted between the inner wheel part 200 and the outer wheel part 300.

The seal body part 710 may be formed of an engineering plastic material. Alternatively, the seal elastic body part 721 may be formed of a composite material such as carbon fiber reinforced plastics (CFRP).

The seal elastic part 720 is mounted on an edge portion of the seal body part 710 and may be formed of an elastically deformable material. The seal elastic part 720 may be formed of an elastically deformable material and block foreign substances while being elastically deformed between the seal body part 710 and the seal fixing part 730.

The seal elastic part 720 includes a seal elastic body part 721, a seal elastic extension part 723, and a seal elastic receiving part 725. The seal elastic body part 721 is disposed at the edge of the seal body part 710. The seal elastic body part 721 has an annular shape and disposed at the edge of the seal body part 710.

The seal elastic extension part 723 is disposed to extend from one side of the seal elastic body part 721 to the seal body part 710. The seal elastic extension part 723 may be disposed to be inclined from one side of the seal elastic body part 721 toward the seal body part 710.

A plurality of seal elastic extension parts 723 may be disposed in the seal elastic body part 721. A plurality of seal elastic extension parts 723 may be disposed in the seal elastic body part 721 to block foreign substances from entering.

The seal elastic part 720 may be formed of rubber or the like and may be elastically deformable.

The seal elastic receiving part 725 is disposed on the other side of the seal elastic body part 721, and the seal fixing part 730 is provided (e.g., received) therein. The seal elastic receiving part 725 is formed in a U-shape, and the seal fixing part 730 is provided therein. The seal fixing part 730 may be press-fitted into the U-shaped seal elastic receiving part 725.

The seal fixing part 730 is mounted on the seal elastic part 720 and supports the seal elastic part 720. The seal fixing part 730 may be made of a steel material. The seal fixing part 730 may be made of a steel material and have rigidity.

According to the wheel bearing apparatus for a vehicle, according to the present disclosure, the drag force can be reduced and fuel efficiency can be improved by reducing the friction surfaces between the ball members 410 of the bearing part 400 and the retainer part 500.

In addition, according to the present disclosure, the area where the encoder magnetic rubber part 620 is mounted on the encoder body part 610 in the encoder part 600 is increased, thereby improving the sensing capability.

In addition, according to the present disclosure, the area of the encoder flange 613 of the encoder body part 610 is increased, so that foreign substances can be effectively prevented from entering the bearing part 400.

In addition, according to the present disclosure, the number of retainer parts 500 can be reduced, so that manufacturing cost and weight of the wheel bearing apparatus can be reduced.

In addition, according to the present disclosure, the weight and cost of the wheel bearing apparatus can be reduced by applying engineering plastic to the seal part 700.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wheel bearing apparatus, comprising:
a hub part configured to be connected to a wheel of a vehicle;
an inner wheel part provided on an outside of the hub part, the inner wheel part being configured to rotate together with the hub part;
an outer wheel part disposed spaced apart from the inner wheel part and fixed to a vehicle body of the vehicle;
a bearing part disposed between the inner wheel part and the outer wheel part, the bearing part being configured to rotatably support the inner wheel part relative to the outer wheel part;
a retainer part coupled to the bearing part, the bearing part being configured to support the bearing part;
an encoder part mounted on the hub part, the encoder part being configured to cover the inner wheel part and to rotate in conjunction with a rotation of the hub part, the encoder part being magnetic; and
a seal part mounted between the inner wheel part and the outer wheel part, the seal part being configured to block foreign substances from entering the bearing part.

2. The wheel bearing apparatus of claim 1, wherein the retainer part comprises:
a retainer body part, the retainer body part being configured in an annular shape, the retained body part being disposed between the inner wheel part and the outer wheel part; and
a retainer support part protruded outwardly from the retainer body part, the retainer support part being configured to rotatably support ball members of the bearing part.

3. The wheel bearing apparatus of claim 2, wherein the retainer body part includes a retainer weight reducing perforation, the retainer weight reducing perforation being defined within the retainer body part.

4. The wheel bearing apparatus of claim 1, wherein the encoder part comprises:
an encoder body part mounted on the hub part, the encoder body part being configured to cover the inner wheel part and to rotate in conjunction with the rotation of the hub part; and
an encoder magnetic rubber part mounted on the encoder body part, the encoder magnetic rubber part comprising a magnetic material.

5. The wheel bearing apparatus of claim 4, wherein the encoder body part comprises:
an encoder cap mounted on the hub part; and
an encoder flange formed stepwise on the encoder cap, the encoder flange being configured to cover the inner wheel part,
wherein the encoder flange comprises the encoder magnetic rubber part.

6. The wheel bearing apparatus of claim 4, wherein the encoder body part comprises Teflon coated provided on a steel material.

7. The wheel bearing apparatus of claim 1, wherein the seal part comprises:
a seal body part mounted between the inner wheel part and the outer wheel part;
a seal elastic part mounted on an edge of the seal body part and comprising an elastically deformable material; and
a seal fixing part mounted on the seal elastic part, the seal fixing part being configured to support the seal elastic part.

8. The wheel bearing apparatus of claim 7, wherein the seal elastic part comprises:
a seal elastic body part disposed on an edge of the seal body part;
a seal elastic extension part disposed to extend from one side of the seal elastic body part to the seal body part; and
a seal elastic receiving part disposed on an other side of the seal elastic body part, the seal elastic part configured to receive the seal fixing part therein.

9. The wheel bearing apparatus of claim 8, further comprising:
a plurality of the seal elastic extension parts disposed within the seal elastic body part.

10. The wheel bearing apparatus of claim 7, wherein the seal body part comprises an engineering plastic material.
